(19) United States
(12) Patent Application Publication
(10) Pub. No.: US 2026/0276346 A1
(43) Pub. Date: Sep. 17, 2026

(54) DISPLAY SYSTEM, AIRCRAFT AND DISPLAY METHOD FOR DISPLAYING A VIRTUAL POINT OF IMPACT ON A HELMET DISPLAY

(71) Applicant: AIRBUS HELICOPTERS, Marignane Cedex (FR)

(72) Inventor: Frédéric FERRIGNO, Marignane Cedex (FR)

(73) Assignee: AIRBUS HELICOPTERS, Marignane Cedex (FR)

(21) Appl. No.: 19/539,661

(22) Filed: Feb. 13, 2026

(30) Foreign Application Priority Data
Mar. 17, 2025 (FR) FR2502503

(51) Int. Cl. F41G 3/22; B60R 11/00; B60R 11/04; F41G 3/06; F41G 3/08; G02B 27/01

(52) U.S. Cl. CPC F41G 3/225; B60R 11/04; F41G 3/06; F41G 3/08; G02B 27/0172; G02B 27/0176; B60R 2011/0003; B60R 2011/004; G02B 2027/0141; G02B 2027/0169

(57) ABSTRACT

A display system configured to display a virtual point of impact on a helmet display. The helmet display is fitted to a helmet worn by an operator of an aircraft. The display system has a measuring member measuring a distance D between at least one sighting member and an obstacle; a first positioning device capable of determining a position and an orientation of the at least one sighting member with respect to the aircraft; a measuring means measuring at least one kinetic parameter related to a movement of the aircraft with respect to the obstacle; a measuring system measuring at least one external parameter related to a speed and orientation of the wind; and a first controller configured to determine a trajectory of a projected element as a function of at least one type of element used, the kinetic parameter, the external parameter, the distance D as well as the position and orientation of the at least one sighting member with respect to the aircraft.

### CROSS REFERENCE TO RELATED APPLICATION

This application claims priority to French patent application No. FR 25 02503 filed on Mar. 17, 2025, the disclosure of which is incorporated in its entirety by reference herein.

### TECHNICAL FIELD

The present disclosure relates to a display system configured to display a virtual point of impact on a helmet display, an aircraft equipped with such a system, and a corresponding display method.

### BACKGROUND

Such a virtual point of impact corresponds to a symbology designating a predicted area of impact between an element projected by at least one sighting member fitted to the aircraft and an obstacle in a surrounding environment.

In addition, such sighting members may, in particular, have an application for enabling a target to be sighted and may comprise an object of elongate shape that may be in the form of a barrel of a weapon, such as a machine gun, but also in the form of a water lance for spraying an area, for example for fighting a fire.

In general, such a sighting member is then able to move in rotation with respect to a frame secured to the aircraft, about two perpendicular axes of rotation. Thus, the sighting member can move in rotation with respect to the chassis and can describe a first rotational movement with respect to a first axis of rotation in elevation and a second rotational movement with respect to a second axis of rotation in azimuth.

Such a sighting member can then be maneuvered by a pilot and the system for displaying the virtual point of impact on the pilot's helmet display makes it possible to accurately predict the area that can be reached with the projected element. Such a display system can then, in particular, avoid projecting the element or elements before knowing the position of the real area of impact.

In general, display systems configured to display a virtual point of impact on a helmet display use algorithms enabling a predicted point of impact to be determined continuously. Such algorithms are referred to by the acronym “CCIP” referring to the expression “Continuously Computed Impact Point”.

However, such display systems, as described in particular in document FR2706599A1, are used by a pilot of an aircraft who is seated in a cockpit of the aircraft. Such a helmet display is then fitted to a helmet worn by an aircraft pilot.

In addition, the display systems comprise an acquisition device capable of determining an orientation of the helmet with respect to the cockpit of the aircraft. Such an acquisition device comprises a camera mounted on the pilot's helmet and a constellation of visual marks, such as stickers, the respective positions of which are known. Such stickers are intended to be filmed by the camera and are therefore attached facing the camera on a wall of the cockpit arranged behind the pilot.

The position of the helmet is substantially always the same, since the pilot always remains seated and harnessed to his seat.

Although such display systems can be used for aircraft pilots, they are not, however, suitable for operators who may be required to move in a cabin, or even at least in part outside the cabin, passing at least partially through an opening arranged in a fuselage of the aircraft.

In addition, documents US2022128823A1 and U.S. Pat. No. 12,117,258B1 are also known but are far from the disclosure.

### SUMMARY

An object of the present disclosure is therefore to propose an innovative display system, aircraft and display method that enable an aircraft operator in the cabin to overcome the above-mentioned limitations.

The disclosure therefore relates to a display system configured to display a virtual point of impact on a helmet display, the helmet display being fitted to a helmet worn by an operator of an aircraft, the virtual point of impact designating a predicted real area of impact between an element projected by at least one sighting member of the aircraft and an obstacle from a surrounding environment, said at least one sighting member being configured to be maneuverable by the operator, the display system comprising at least one identification assembly comprising:
a measuring member measuring a distance D between said at least one sighting member and said obstacle;
a first positioning device capable of determining a position and an orientation of said at least one sighting member with respect to the aircraft;
a measuring means measuring at least one kinetic parameter related to a movement of said aircraft with respect to said obstacle;
a measuring system measuring at least one external parameter related to a speed and orientation of the wind;
a first controller, such as a mission computer for example, configured to determine a trajectory of the projected element as a function of at least one type of element used, the kinetic parameter, the external parameter, the distance D as well as the position and orientation of said at least one sighting member with respect to the aircraft;
a second positioning device capable of determining a position and an orientation of the helmet with respect to the aircraft; and
a second controller configured to identify, on the helmet display, the position of the virtual point of impact as a function of the trajectory of the element and of the position and orientation of the helmet with respect to the aircraft.

In addition, such a member for measuring a distance between said at least one sighting member and the obstacle may comprise, for example, a camera, a sensor of an electro-optical system or a laser rangefinder mounted on the sighting member. The device for measuring this distance is then connected by wired or wireless means to the first controller in order to transmit the measured distance instantaneously in real time.

The first positioning device capable of determining a position and an orientation of said at least one sighting member with respect to the aircraft may then comprise direct and/or indirect measuring means.

Such direct measuring means may comprise various electrical sensors such as, for example:
one or more encoder wheels for measuring an angle of rotation of a shaft using digital or analog signals generated by the rotation of a graduated disk;
one or more MEMS-type microgyroscopes capable of measuring accelerations with respect to changes in angular orientations; and
one or more inclinometers for detecting one or more angles of inclination of the sighting member as a function of the gravitational force.

The indirect measuring means may comprise cameras for measuring distances between the sighting member and reference points on the aircraft and a processing unit configured to then determine a position and an angular orientation by trigonometry of said at least one sighting member with respect to the aircraft. The position may be measured with respect to a fixed marker attached to a support of the sighting member or to a fuselage of the aircraft, also filmed by the cameras.

The means for measuring at least one kinetic parameter related to a movement of the aircraft with respect to the obstacle may comprise, for example, an inertial unit or a satellite-based positioning system such as a Galileo, GPS, GLONASS system, etc.

The system for measuring at least one external parameter related to a speed and an orientation of the wind may, for example, comprise a Doppler-effect anemometer sensor, Pitot tubes or hot-wire sensors.

As with the measured distance, all these measurements are then transmitted by wired or wireless means to the first controller that deduces a trajectory according to the type of projected element used and in particular its mass, its speed of movement at the output of the sighting member and a stored law.

Such a first controller may thus, for example, comprise a memory wherein a table of values is stored, this table of values comprising the characteristics of the trajectory of the projected element as a function, in particular, of its speed, its mass, the speed and direction of the wind and the speed and direction of movement of the sighting member with respect to the obstacle.

In addition, when the display system is activated, an operator may see the virtual point of impact on his helmet display in the form of a symbol, such as a circle or cross. This symbol is then displayed in transparency and superimposed on the surrounding environment seen by the operator through his helmet display that can, for example, be integrated into a visor or screen of the helmet.

Moreover, when the predicted area of impact is not within the operator's field of view, i.e., if the virtual point of impact should be positioned outside the display, another symbol, such as an arrow, may be displayed on his helmet display. This arrow then indicates to the operator which direction to turn his head in order to be able to see the virtual point of impact.

Furthermore, such a virtual point of impact may move on the helmet display as a function of the trajectory of the projected element that is calculated in real time by the first controller and of the position and orientation of the helmet with respect to the aircraft. In addition, such an operator is not a pilot of the aircraft and is therefore not seated in a cockpit of the aircraft.

The operator is then located in a cabin external to the cockpit and can move within this cabin.

In addition, the first and second controller may be separate or combined and they may comprise, for example, at least one processor and at least one memory, at least one integrated circuit, at least one programmable system or at least one logic circuit, these examples not limiting the scope to be given to the term “controller”. The term “processor” may refer equally to a central processing unit or CPU, a graphics processing unit or GPU, a digital signal processor or DSP, a microcontroller, etc.

In addition, the second positioning device comprises first sensors arranged in an interior volume located inside a cabin of the aircraft, and second sensors arranged in at least one exterior volume located exterior to said cabin, said cabin being located outside a cockpit of the aircraft, said at least one exterior volume being separated from the interior volume by at least one opening of the cabin communicating with the surrounding environment.

In this way, the second positioning device enables the position and orientation of the helmet worn by the operator to be detected, even when the operator is moving in and outside of the cabin, and in particular if the operator passes his helmet entirely or partially through the opening into the surrounding environment.

In practice, the first positioning device may comprise third sensors arranged in the volume exterior to the cabin.

As already mentioned, these third sensors arranged in the volume exterior to the cabin may be the aforementioned direct or indirect measuring means.

Advantageously, the second sensors and the third sensors may be combined and may comprise at least two external cameras arranged against a fuselage of the aircraft. In addition, the at least two external cameras may be arranged on either side of said at least one opening of the cabin.

In this way, the first and second positioning devices, respectively for the position and orientation of said at least one sighting member as well as for the position and orientation of the helmet with respect to the aircraft, can be shared in order, in particular, to limit the mass and complexity of installation of the display system.

According to one particular exemplary embodiment of the disclosure, the at least two external cameras may comprise an upper external camera and a lower external camera, the upper external camera being oriented in a first downward external direction and arranged above said at least one opening in an elevation direction oriented vertically when the aircraft rests on the ground, the lower external camera being oriented in a second upward external direction distinct from the first external direction and arranged below said at least one opening in the elevation direction.

Thus, the upper and lower external cameras jointly have a global field of view making it possible to scan all the positions and orientations of said at least one sighting member as well as all the positions and orientations of the helmet worn by the operator outside the cabin.

In another aspect, the first sensors may comprise at least two internal cameras arranged against a ceiling of the cabin and on either side of said at least one opening of the cabin.

Consequently, the internal cameras jointly present a global field of view making it possible to scan all the positions and orientations of the helmet worn by the operator inside the cabin.

In practice, said at least two internal cameras may comprise at least one front internal camera (41, 43) and at least one rear internal camera, said at least one front internal camera being oriented in a first internal direction downwards and towards the rear and arranged in a front zone with respect to said at least one opening in a longitudinal direction oriented from a tail towards a nose of the aircraft, said at least one rear internal camera being oriented in a second internal direction downwards and towards the front, distinct from the first internal direction, and arranged in a rear zone with respect to said at least one opening in the longitudinal direction.

Such front and rear internal cameras may further be offset with respect to a vertical median plane parallel to the longitudinal direction, the front internal camera or cameras then being arranged away from the vertical median plane, and the rear internal camera or cameras then being arranged close to the vertical median plane.

Advantageously, said at least one front internal camera may comprise a left front internal camera and a right front internal camera arranged on either side of a vertical median plane parallel to said longitudinal direction.

According to another exemplary embodiment of the disclosure, said at least one rear internal camera may comprise a left rear internal camera and a right rear internal camera arranged on either side of a vertical median plane parallel to the longitudinal direction.

In another aspect, the aircraft being equipped with two sighting members and two corresponding openings, the system may comprise two identification assemblies and a selection interface enabling said operator to select one of said two sighting members to be maneuvered and to display on the helmet display the virtual point of impact corresponding to the selected sighting member (2, 2′).

Such a selection interface may, in particular, comprise a bistable toggle switch that can be moved between a first selection position for alternately selecting a display of a first virtual point of impact corresponding to a first sighting member, or a display of a second virtual point of impact corresponding to a second sighting member distinct from the first sighting member.

In practice, the two sighting members may be arranged respectively on a left flank and a right flank of the aircraft on either side of a vertical median plane parallel to a longitudinal direction oriented from a tail towards a nose of the aircraft.

Consequently, the same operator can alternately maneuver a first sighting member oriented towards an obstacle located on the left of the aircraft and a second sighting member oriented towards an obstacle located on the right of the aircraft.

Advantageously, said at least one sighting member may comprise a sighting camera oriented towards the obstacle, the helmet display displaying at least one image transmitted by the sighting camera and comprising the obstacle.

In other words, in this case, the operator does not need to look directly at the external environment in order to see the obstacle sighted by the sighting member. This operator can have video feedback of the images from the sighting camera on his helmet display. Thus, when the display system is activated, an operator can see, on his helmet display, the virtual point of impact displayed superimposed on at least one image of the surrounding environment transmitted by the sighting camera.

The disclosure also relates to an aircraft comprising a display system configured to display a virtual point of impact on a helmet display,

Such an aircraft comprises the display system as described above.

The present disclosure also relates to a method for displaying a virtual point of impact on a helmet display, the helmet display being fitted to a helmet worn by an operator of an aircraft, the virtual point of impact designating a predicted real area of impact between an element projected by at least one sighting member of the aircraft and an obstacle from a surrounding environment, said at least one sighting member being configured to be maneuverable by the operator, the display method comprising the steps of:
measuring a distance D between said at least one sighting member and the obstacle;
determining a position and an orientation of said at least one sighting member with respect to the aircraft;
measuring at least one kinetic parameter related to a movement of the aircraft with respect to the obstacle;
measuring at least one external parameter related to a speed and orientation of the wind;
determining a trajectory of the projected element as a function of at least one type of element used, the kinetic parameter, the external parameter, the distance D as well as the position and orientation of said at least one sighting member with respect to the aircraft;
determining a position and an orientation of the helmet with respect to the aircraft, this determination being able to be carried out in a free environment both inside and exterior to the cabin; and
identifying, on the helmet display, the position of the virtual point of impact as a function of the trajectory of the element and of the position and orientation of the helmet with respect to the aircraft.

The method wherein the determining of a position and an orientation of the helmet with respect to the aircraft is carried out both in an interior volume located inside a cabin of the aircraft and in an exterior volume located exterior to the cabin, the cabin being located outside a cockpit of the aircraft, said exterior volume being separated from the interior volume by at least one opening of the cabin communicating with the surrounding environment.

In other words, such a display method enables an operator located in a cabin to view a virtual point of impact on his helmet display before projecting an element onto an obstacle in the surrounding environment.

### BRIEF DESCRIPTION OF THE DRAWINGS

The disclosure and its advantages appear in greater detail from the following description of examples given by way of illustration with reference to the accompanying figures, wherein:

FIG. 1 is a perspective view of an aircraft according to the disclosure;

FIG. 2 is a perspective view of an exterior portion of the aircraft of FIG. 1;

FIG. 3 is a perspective cross-sectional view of an aircraft according to the disclosure;

FIG. 4 is a sectional view from above of an aircraft according to the disclosure; and

FIG. 5 is a logic diagram showing a display method according to the disclosure.

### DETAILED DESCRIPTION

Elements present in more than one of the figures are given the same references in each of them.

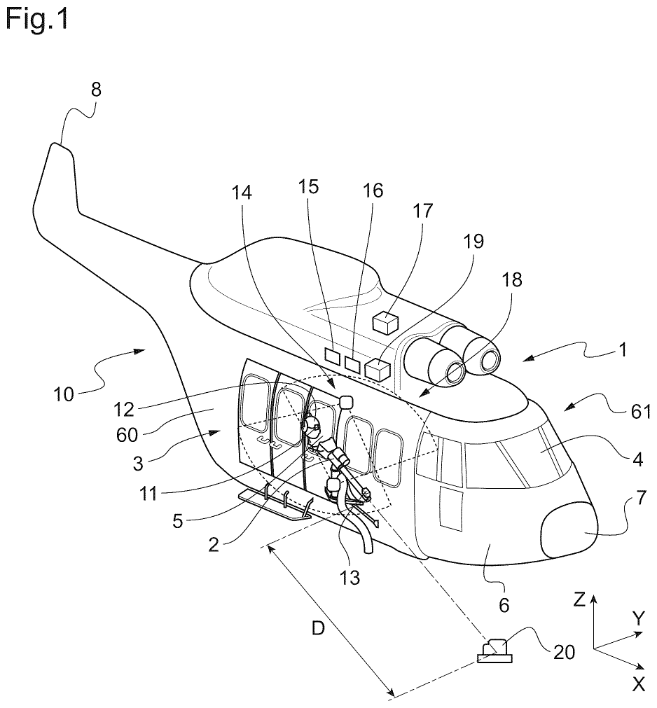

Three mutually orthogonal directions X, Y, and Z are indicated in FIGS. 1 to 4.

The first direction X is referred to as longitudinal. The term “longitudinal” relates to any direction parallel to the first direction X.

The second direction Y is referred to as transverse. The term “transverse” relates to any direction parallel to the second direction Y.

Finally, the third direction Z is referred to as in elevation. The expression “in elevation” relates to any direction parallel to the third direction Z.

As shown in FIG. 1, the aircraft 1 may be in the form of a rotorcraft or a helicopter in particular, and comprise at least one rotor participating in the lift, or even the propulsion, of the aircraft 1 in the air.

An operator of an aircraft 1 is then positioned in a cabin 3 separate from a cockpit 4 that hosts at least one pilot. The operator can then maneuver at least one sighting member 2, 2′ fitted to the aircraft 1. Such a sighting member 2, 2′ may, in particular, enable a target to be sighted and may comprise an object of elongate shape that may be in the form of a barrel of a weapon, such as a machine gun, but also in the form of a water lance for spraying a target, for example for fighting a fire.

The sighting member 2, 2′ can thus enable an element, a projectile or water to be projected in the direction of an object, a fire or more generally towards an obstacle 20 in the surrounding environment.

Such an aircraft 1 then comprises a display system 10 configured to display a virtual point of impact on a helmet display 11 fitted to a helmet 12 worn by the operator.

Such a virtual point of impact then corresponds to a symbology designating a real area of impact, estimated by calculations, able to be reached by a projected element under the current conditions. Thus, the virtual point of impact is substantially located on a straight line from the real area of impact to the eyes of the operator.

To do this, the display system 10 comprises at least one external 60 and internal 61 identification assembly comprising a measuring member 13 measuring a distance D between said at least one sighting member 2, 2′ and the obstacle 20. Such a measuring member 13 may comprise, for example, a camera, a sensor of an electro-optical system or a laser rangefinder mounted on the sighting member 2, 2′.

Furthermore, the at least one identification assembly 60, 61 comprises a first positioning device 14 capable of determining a position and an orientation of the sighting member 2, 2′ with respect to the aircraft 1.

The at least one identification assembly 60, 61 comprises a measuring means 15 measuring at least one kinetic parameter related to a movement of said aircraft 1 with respect to the obstacle 20.

The at least one identification assembly 60, 61 comprises a measuring system 16 measuring at least one external parameter related to a speed and orientation of the wind.

The at least one identification assembly 60, 61 then comprises a first controller 17 connected by wired or wireless means to the measuring member 13, to the first positioning device 14, to the measuring means 15 and to the measuring system 16.

A first controller 17 thus receives digital or analog electrical signals representative of the various measurements, determinations and optionally calculations. The first controller 17 is, more specifically, configured to determine, using a stored law established by trials and/or computations and/or simulations, that may comprise at least one equation or an artificial intelligence or any other usual form, for example a trajectory of the projected element as a function of at least one type of element used, the kinetic parameter, the external parameter, the distance D as well as the position and orientation of the sighting member 2, 2′ with respect to the aircraft 1.

In addition, the type of element used may impact the predicted trajectory since it will depend, in particular, on the mass of the element or its speed of movement at the outlet of the sighting member 2, 2′.

Such a first controller 17 may thus comprise a memory wherein a table of values is stored and comprises technical characteristics relating to the projected element such as its speed, its mass, its possible deviation as a function of the speed and direction of the wind and the speed and direction of movement of the sighting member 2, 2′ with respect to the obstacle 20.

Furthermore, the at least one identification assembly 60, 61 likewise comprises a second positioning device 18 capable of determining a position and orientation of the helmet 12 with respect to the aircraft 1 and a second controller 19 configured to identify, on the helmet display 11, the position of the virtual point of impact as a function of the trajectory of the element as well as the position and orientation of the helmet 12 with respect to the aircraft 1.

According to the example in FIG. 1, the first controller 17 and the second controller 19 may be different and separate from each other. According to one variant of such a display system (not shown), the first controller 17 and the second controller 19 may be combined and form part of a computing assembly such as a mission computer fitted to the aircraft 1.

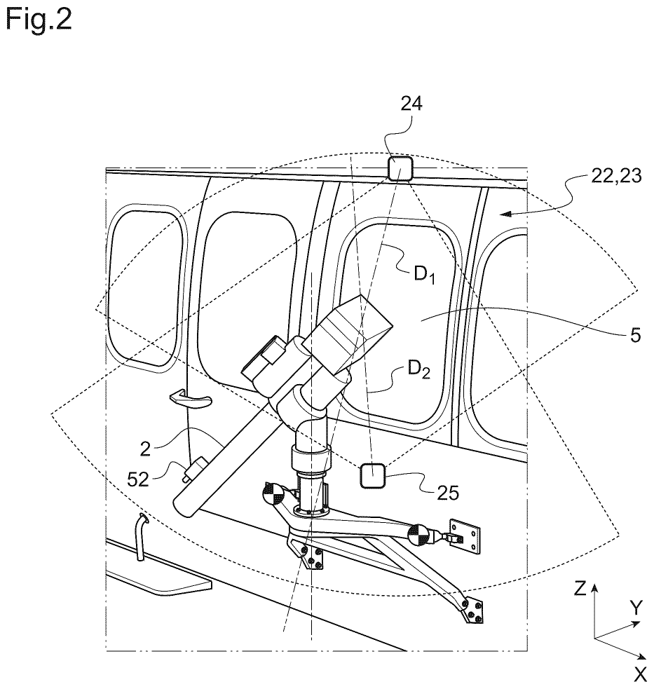

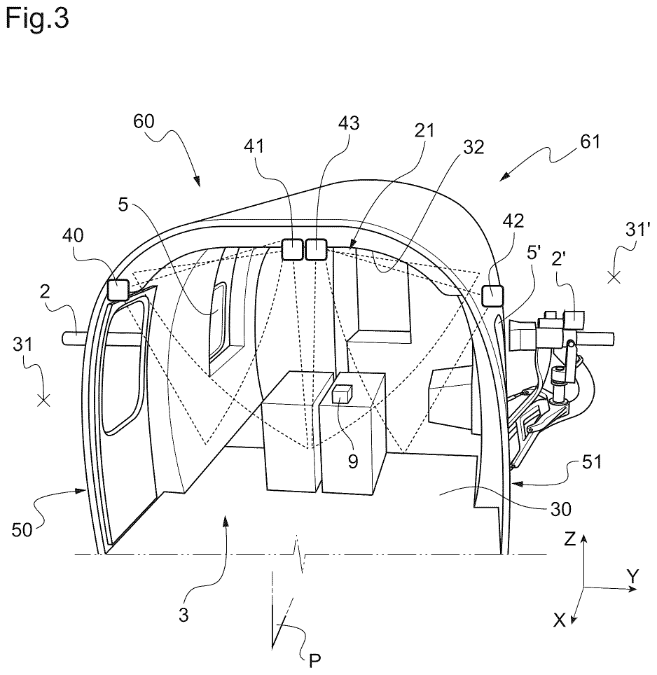

In addition, as shown in more detail in FIG. 2 and FIG. 3, such a second positioning device 18 comprises first sensors 21 arranged in an interior volume 30 located inside the cabin 3 receiving the operator, and second sensors 22 arranged in at least one exterior volume 31, 31′ located outside the cabin 3.

In addition, such an exterior volume 31, 31′ may be arranged laterally in the transverse direction Y with respect to at least one opening 5, 5′ formed in the fuselage 6 at the cabin 3. Such openings 5, 5′ thus make it possible to make the cabin 3 communicate with the surrounding environment and, in particular, for the operator to grasp the sighting member 2, 2′ in order to maneuver it.

In addition, the first positioning device 14 comprises third sensors 23 arranged in the exterior volume 31, 31′.

The expressions first, second and third sensors should be understood here to mean both physical sensing elements capable of directly measuring the parameter in question, but also systems that may comprise one or more physical sensing elements as well as means for processing the signal that make it possible to provide an estimation of the parameter based on the measurements provided by these physical sensing elements. Similarly, the notion of measuring parameters refers to both a raw measurement from a physical sensing element and a measurement obtained by relatively complex processing of raw measurement signals.

In order to limit the mass and to simplify the electrical architecture of the display system 10, the second sensors and the third sensors may be combined and comprise at least two external cameras 24, 25 arranged against the fuselage 6 of the aircraft 1 and on either side of the opening 5, 5′.

Such a display system 10 may thus comprise a shared architecture for determining the position and orientation of the helmet 12 and for determining the position and orientation of the sighting member 2, 2′ with respect to the aircraft 1. The cameras 24, 25 can communicate with a processing unit configured to analyze the images in a known manner and to perform the aforementioned calculations.

Furthermore, the at least two external cameras 24, 25 may comprise an upper external camera 24 and a lower external camera 25. The upper external camera 24 is thus oriented in a first downward external direction D1 and arranged above the opening 5, 5′ in the elevation direction Z.

Similarly, the lower external camera 25 is oriented in a second upward external direction D2 distinct from the first external direction D1 and arranged below the opening 5, 5′ in the elevation direction Z.

Furthermore, the sighting member 2, 2′ may also be fitted with a sighting camera 52, 52′ that is integral with the sighting member 2, 2′ and therefore configured to be oriented in the direction of the obstacle 20. This sighting camera 52, 52′ makes it possible to generate at least one image or video stream that is transmitted to the helmet display 11 of the helmet 12 worn by the operator.

The helmet display 11 can then, if necessary, display this or these images transmitted by the sighting camera 52, 52′ and the operator can see a representation of the obstacle 20 and, in superposition, the virtual point of impact. Such an embodiment can, in particular, be used if the operator is arranged behind an opaque wall that does not allow him to view the entire external environment, and in particular the obstacle 20.

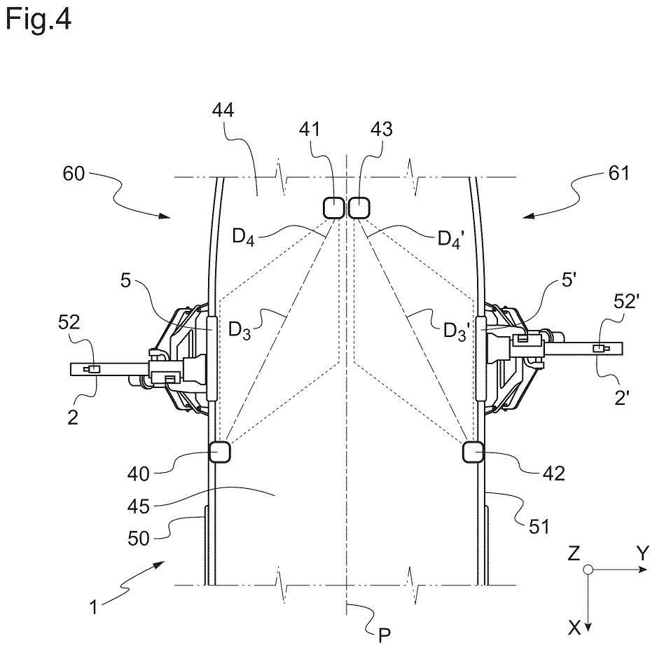

In addition, the first sensors 21 may comprise at least two internal cameras 40, 41, 42, 43, and, for example, four internal cameras 40, 41, 42, 43, as shown in FIGS. 3 and 4. The cameras 40 to 43 can communicate with a processing unit configured to analyze the images in a known manner and to perform the aforementioned calculations.

These four internal cameras 40, 41, 42, 43 are then arranged against a ceiling 32 of the cabin 3 and on either side of said at least one opening 5, 5′ of the cabin 3 in the longitudinal direction X oriented from a tail 8 towards a nose 7 of the aircraft 1.

Thus, said at least two internal cameras 40, 41, 42, 43 may comprise at least one front internal camera 41, 43 and at least one rear internal camera 40, 42 with respect to said at least one opening 5, 5′.

Each front internal camera 41, 43 is oriented in a first internal direction D4, D4′ downwards and rearwards and arranged in a front zone 44 of the cabin with respect to said at least one opening 5, 5′ in the longitudinal direction X.

Each rear internal camera 40, 42 is in turn oriented in a second internal direction D3, D3′ downwards and forwards, distinct from said first internal direction D4, D4′, and arranged in a rear zone 45 with respect to said at least one opening 5, 5′ in the longitudinal direction X.

More precisely, said at least one front internal camera 41, 43 may comprise a left front internal camera 41 and a right front internal camera 43 arranged on either side of a vertical median plane P.

Similarly, said at least one rear internal camera 40, 42 may comprise a left rear internal camera 40 and a right rear internal camera 42 arranged on either side of the vertical median plane P.

Furthermore, when the aircraft 1 is equipped with two sighting members 2, 2′ and two corresponding openings 5, 5′ allowing the operator to alternately maneuver the two sighting members 2, 2′, the system 10 may comprise two identification assemblies as described above and a selection interface 9 enabling the operator to select one of said two sighting members 2, 2′ that he wishes to maneuver. Such a selection interface 9 then makes it possible to select a display, on the helmet display 11, of the virtual point of impact corresponding to the selected sighting member 2, 2′.

For example, the two sighting members 2, 2′ may be arranged respectively on a right flank 51 and a left flank 50 of the aircraft 1, on either side of the vertical median plane P.

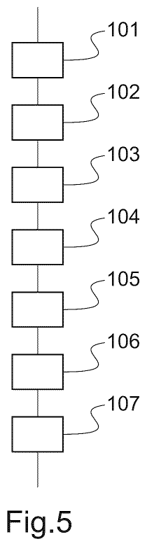

As shown in FIG. 5, the disclosure also relates to a method 100 for displaying a virtual point of impact on the above-mentioned helmet display 11.

This display method 100 comprises measuring 101 the distance D between at least one of the sighting members 2, 2′ and the obstacle 20, this measuring 101 being implemented by means of the measuring member 13.

The display method 100 also comprises determining 102 a position and an orientation of said at least one sighting member 2, 2′ with respect to the aircraft 1, such a determining 102 being implemented using the first positioning device 14.

The display method 100 comprises measuring 103 at least one kinetic parameter related to a movement of the aircraft 1 with respect to the obstacle 20, this measuring 103 being implemented using the measuring means 15.

The display method 100 also comprises measuring 104 at least one external parameter related to a speed and to an orientation of the wind using the measuring system 16 and determining 105, using the first controller 17, a trajectory of the projected element as a function at least of a type of element used, the kinetic parameter, the external parameter, the distance D as well as of the position and the orientation of said at least one sighting member 2, 2′ with respect to the aircraft 1.

Then, the method 100 comprises a step 106 of determining, using the second positioning device 18, a position and an orientation of the helmet 12 with respect to the aircraft 1, then a step 107 of identifying, using the second controller 19, on the helmet display 11, the position of the virtual point of impact as a function of the trajectory of the element and the position and orientation of the helmet 12 with respect to the aircraft 1.

Advantageously, the step 106 of determining a position and an orientation of the helmet 12 with respect to the aircraft 1 may be implemented alternatively in the interior volume 30 and in the exterior volume or volumes 31, 31′.

Finally, the method 100 implements the display of a symbol illustrating such a virtual point of impact on the helmet display 11, this symbol taking, for example, the form of a circle, if the real area of impact is in the field of view of the operator.

If this is not the case, the helmet display 12 may display another symbol, such as an arrow, to indicate to the operator in which direction to turn his head in order to be able to display the virtual point of impact on the helmet display 11.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A display system configured to display a virtual point of impact on a helmet display, the helmet display being fitted to a helmet worn by an operator of an aircraft, the virtual point of impact designating a predicted real area of impact between an element projected by at least one sighting member of the aircraft and an obstacle of a surrounding environment, the at least one sighting member being configured to be maneuverable by the operator, the display system comprising at least one identification assembly comprising:
a measuring member measuring a distance D between the at least one sighting member and the obstacle;
a first positioning device capable of determining a position and an orientation of the at least one sighting member with respect to the aircraft;
a measuring means measuring at least one kinetic parameter related to a movement of the aircraft with respect to the obstacle;
a measuring system measuring at least one external parameter related to a speed and orientation of the wind;
a first controller configured to determine a trajectory of the projected element as a function of at least one type of element used, the kinetic parameter, the external parameter, the distance D as well as the position and orientation of the at least one sighting member with respect to the aircraft;
a second positioning device capable of determining a position and an orientation of the helmet with respect to the aircraft; and
a second controller configured to identify, on the helmet display, the position of the virtual point of impact as a function of the trajectory of the element and of the position and orientation of the helmet with respect to the aircraft;
wherein the second positioning device comprises first sensors arranged in an interior volume located inside a cabin of the aircraft, and second sensors arranged in at least one exterior volume located exterior to the cabin, the cabin being located outside a cockpit of the aircraft, the at least one exterior volume being separated from the interior volume by at least one opening of the cabin communicating with the surrounding environment.

2. The display system according to claim 1,
wherein the first positioning device comprises third sensors arranged in the volume exterior to the cabin.

3. The display system according to claim 1,
wherein the first positioning device comprises third sensors arranged in the volume exterior to the cabin; and
wherein the second sensors and the third sensors are combined and comprise at least two external cameras arranged against a fuselage of the aircraft.

4. The display system according to claim 3,
wherein the at least two external cameras are arranged on either side of the at least one opening of the cabin.

5. The display system according to claim 4,
wherein the at least two external cameras comprise an upper external camera and a lower external camera, the upper external camera being oriented in a first downward external direction and arranged above the at least one opening in an elevation direction oriented vertically when the aircraft rests on the ground, the lower external camera being oriented in a second upward external direction distinct from the first external direction and arranged below the at least one opening in the elevation direction.

6. The display system according to claim 1,
wherein the first sensors comprise at least two internal cameras arranged against a ceiling of the cabin and on either side of the at least one opening of the cabin.

7. The system according to claim 6,
wherein the at least two internal cameras comprise at least one front internal camera and at least one rear internal camera, the at least one front internal camera being oriented in a first internal direction downwards and towards the rear and arranged in a front zone with respect to the at least one opening in a longitudinal direction oriented from a tail towards a nose of the aircraft, the at least one rear internal camera being oriented in a second internal direction downwards and towards the front, distinct from the first internal direction, and arranged in a rear zone with respect to the at least one opening in the longitudinal direction.

8. The system according to claim 7,
wherein the at least one front internal camera comprises a left front internal camera and a right front internal camera arranged on either side of a vertical median plane parallel to the longitudinal direction.

9. The system according to claim 7,
wherein the at least one rear internal camera comprises a left rear internal camera and a right rear internal camera arranged on either side of a vertical median plane parallel to the longitudinal direction.

10. The system according to claim 1,
wherein, with the aircraft being equipped with two sighting members and two corresponding openings, the system comprises two identification assemblies and a selection interface enabling the operator to select one of the two sighting members to be maneuvered and to display on the helmet display the virtual point of impact corresponding to the selected sighting member.

11. The system according to claim 10,
wherein the two sighting members are arranged respectively on a right flank and a left flank of the aircraft on either side of a vertical median plane parallel to a longitudinal direction oriented from a tail towards a nose of the aircraft.

12. The system according to claim 1,
wherein the at least one sighting member comprises a sighting camera oriented towards the obstacle, the helmet display displaying at least one image transmitted by the sighting camera and comprising the obstacle.

13. An aircraft comprising the display system configured to display a virtual point of impact on a helmet display,
wherein the display system is according to claim 1.

14. A method for displaying a virtual point of impact on a helmet display, the helmet display being fitted to a helmet worn by an operator of the aircraft, the virtual point of impact designating a predicted real area of impact between an element projected by at least one sighting member of the aircraft and an obstacle of a surrounding environment, the at least one sighting member being configured to be maneuverable by the operator, the method comprising the steps of:
measuring a distance D between the at least one sighting member and the obstacle;
determining a position and an orientation of the at least one sighting member with respect to the aircraft;
measuring at least one kinetic parameter related to a movement of the aircraft with respect to the obstacle;
measuring at least one external parameter related to a speed and orientation of the wind;
determining a trajectory of the projected element as a function of at least one type of element used, the kinetic parameter, the external parameter, the distance D as well as the position and orientation of the at least one sighting member with respect to the aircraft; and
determining a position and an orientation of the helmet with respect to the aircraft;
identifying on the helmet display, the position of the virtual point of impact as a function of the trajectory of the element and of the position and orientation of the helmet with respect to the aircraft;
wherein the determining of a position and an orientation of the helmet with respect to the aircraft is carried out both in an interior volume located inside a cabin of the aircraft and in an exterior volume located exterior to the cabin, the cabin being located outside a cockpit of the aircraft, the exterior volume being separated from the interior volume by the at least one opening of the cabin communicating with the surrounding environment.
